(19) United States
(12) Patent Application Publication
(10) Pub. No.: US 2008/0052510 A1
(43) Pub. Date: Feb. 28, 2008

(54) MULTI CERTIFICATE REVOCATION LIST SUPPORT METHOD AND APPARATUS FOR DIGITAL RIGHTS MANAGEMENT

(75) Inventors: Yeo-jin KIM, Suwon-si (KR); Yun-sang OH, Seoul (KR); Sang-gyoo SIM, Suwon-si (KR); Kyung-im JUNG, Seongnam-si (KR); Ji-soo KIM, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/739,926

(22) Filed: Apr. 25, 2007

Related U.S. Application Data
(60) Provisional application No. 60/799,652, filed on May 12, 2006.

(30) Foreign Application Priority Data
Jan. 31, 2007 (KR) 10-2007-0010277

(51) Int. Cl. H04L 9/00

(52) U.S. Cl. 713/158

(57) ABSTRACT

The present invention provides a multi certificate revocation list (CRL) support method and apparatus for digital rights management (DRM). A multi CRM support method for DRM includes: receiving a first CRL and validating an issuer identification (ID) of the first CRL; loading a second CRL corresponding to the issuer ID and determining which of the first and second CRLs is the most updated CRL; and updating one of the first and second CRLs with the most updated CRL, based on a result of the determining.

### CROSS REFERENCE TO RELATED APPLICATIONS

This application claims priority from Korean Patent Application No. 10-2007-10277 filed on Jan. 31, 2007 in the Korean Intellectual Property Office, and U.S. Provisional Patent Application No. 60/799,652 filed on May 12, 2006 in the United States Patent and Trademark Office, the disclosures of which are incorporated herein by reference in their entirety.

### BACKGROUND OF THE INVENTION

1. Field of the Invention

Methods and apparatuses consistent with the present invention relate to a multi certificate revocation list support for digital rights management, and more particularly, to a multi certificate revocation list support for digital rights management capable of classifying and managing certificate revocation lists issued by different certificate revocation list issuers to ensure reliability among several digital rights managing apparatuses.

2. Description of the Related Art

In recent years, research on digital rights management has been conducted, and commercial services using digital rights management have been provided.

Digital data can be copied without loss, unlike analog data, and can be easily reused and processed. In addition, the digital data can be easily distributed to a third party.

Further, it is possible to distribute and copy the digital data at a very low cost. In contrast, a great deal of labor, cost, and time are required to create digital contents, and a technique for protecting various digital copyrights is demanded. In compliance with such a demand, the digital rights management has been applied to various fields.

An attempt has been made to prevent unauthorized access to digital contents to protect the digital contents.

Therefore, access to digital contents is permitted to some authorized persons who buy access rights, such that unauthorized persons cannot access the digital contents. When an authorized person accesses digital contents and intentionally distributes the accessed digital contents to an unauthorized person, the unauthorized person can use the digital contents without payment, which causes serious problems.

In contrast, in digital rights management, access to digital contents is permitted to everybody without restriction. However, since the digital contents are encoded, a specific license is needed to execute the digital contents. Therefore, digital rights management can effectively protect digital contents.

FIG. 1 is a diagram illustrating the conception of general digital rights management.

The digital rights management relates to a license management method of managing contents protected by encryption or scrambling (hereinafter, referred to as encoded contents) and access to the encoded contents.

FIG. 1 shows devices 110 and 150 that want to access encoded contents, a contents issuer 120 for providing contents, a rights issuer 130 that issues a rights object including a license to execute contents, and a certificate authority 140 that issues certificates.

A device A 110 can obtain desired contents from the contents issuer 120, and the contents are encoded.

The device A 110 can buy a rights object including a license to use the encoded contents from the rights issuer 130, and the device A 110 having bought the rights object can use the encoded contents.

Since the encoded contents can be freely distributed, the device A 110 can freely transmit the encoded content to a device B 150.

The device B 150 needs to have a rights object in order to reproduce the received encoded contents, and the rights object can be obtained from the rights issuer 130.

The certificate authority 140 issues a certificate having the name of a device whose public key is validated, a certificate serial number, the name of a certificate authority issuing the certificate, and a message indicating the public key of a corresponding device and the expiration date of the certificate written thereon.

Each device can check whether another device communicating with the corresponding device is authorized through the certificate issued by the certificate authority 140.

Since each certificate is signed by a secret key of the certificate authority 140 in order to check whether the certificate is approved, the device can use the public key of the certificate authority 140 to confirm a certificate of another device communicating with the device.

The certificate may be stored in a place that is easy to access from each device, such as a directory service system, or it may be stored in the corresponding device.

All the devices need to be issued with their certificates from the certificate authority 140 in order to improve security in communication.

However, the certificates issued by the certificate authority 140 may be revoked before their expiration dates.

For example, when a secret key of a specific device is damaged or leaked to the outside, the certificate of the device may be revoked such that other devices confirm the revocation of the certificate.

Various methods of checking whether a valid certificate of a device is revoked have been proposed. For example, certificates of all valid devices on an on-line are stored in a directory service system that is easy to access, and the certificates are generally used.

For example, when a device wants to access to a server, the server can access a directory service system to check whether a certificate of the device exists.

When the certificate of the device does not exist in the directory service system, the server may determine that the certificate of the device is revoked.

As another method of checking whether a valid certificate of a device is revoked, a certificate authority issues a certificate revocation list (CRL), that is, a list of revoked certificates.

The CRL is regularly/irregularly updated, and a new CRL is issued. Then, the certificate authority can distribute the issued CRL.

Each device searches a certificate of another device communicating with the device from the issued CRL. When the certificate is not included in the CRL, it may be determined that the device is valid.

When the certificate of the other device is included in the CRL, the device determines that the other device is invalid and may stop communication with the other device.

FIG. 2 is a diagram illustrating the issue and update of a CRL in a digital rights management (DRM) system according to the related art.

A CRL issuer 201 creates a CRL 201a for certificate revocation records of all devices 202 to 204 forming the DRM system and distributes the CRL through a network 205. The devices 202 to 204 of the DRM system receive the most updated CRL from the CRL issuer 201 or the other devices and store the received CRL.

Each of the devices 202 to 204 tests the CRL 201a in order to check whether the other devices are damaged when communicating with the other devices. In this case, when CRLs 201a stored in two devices are compared and the issue times of the CRLs 201a are different from each other, a CRL issued earlier is updated with the most updated CRL.

However, in the related art, when CRLs issued by two different CRL issuers are stored in one device, collision may occur therebetween.

That is, since a corresponding device does not know which CRL is to be loaded during a CRL test and update, it is difficult to design a dispersion CRL considering the type of DRM, a DRM system apparatus, and a CRL issuer.

In addition, since CRLs related to all devices forming the DRM system are recorded on one CRL, the size of CRL increases. Therefore, during communication between two devices, when one device examines a CRL of the other device, unnecessary information is also exchanged between two devices, which causes the management efficiency of CRL to be lowered.

### SUMMARY OF THE INVENTION

The present invention provides a multi certificate revocation list support method and apparatus for digital rights management capable of classifying and managing certificate revocation lists issued by different certificate revocation list issuers to ensure reliability among several digital rights managing apparatuses.

According to an aspect of the present invention, there is provided a multi certificate revocation list support method for digital rights management, the method comprising: receiving a first certificate revocation list and validating an issuer identification (ID) of the first certificate revocation list; loading a second certificate revocation list corresponding to the issuer ID and determining which of the first and second certificate revocation lists is the most updated certificate revocation list; and updating one of the first and second certificate revocation lists with the most updated certificate revocation list, based on a result of the determining.

According to another aspect of the present invention, there is provided a multi certificate revocation list support method for digital rights management, the method comprising: transmitting a certificate revocation list including an issuer ID of the certificate revocation list; receiving one of a response message notifying that the certificate revocation list has been updated and an update request message according to whether the certificate revocation list is a most updated certificate revocation list; and determining whether to update the certificate revocation list, based on one of the response message and the update request message.

According to another aspect of the present invention, there is provided a multi certificate revocation list support apparatus for digital rights management, the apparatus comprising: an ID validation unit which receives a first certificate revocation list and validates an issuer ID of the first certificate revocation list; an update determining unit which loads a second certificate revocation list corresponding to the issuer ID and determines which of the first and second certificate revocation lists is the most updated certificate revocation list; and an update unit which updates one of the first and second certificate revocation lists with the most updated certificate revocation list, based on a result of the determination by the update determining unit.

According to another aspect of the present invention, there is provided a multi certificate revocation list support apparatus for digital rights management, the apparatus comprising: a transmitting unit which transmits a certificate revocation list including an issuer ID of the certificate revocation list; a receiving unit which receives one of a response message notifying that the certificate revocation list has been updated and an update request message according to whether the certificate revocation list is a most updated certificate revocation list; and an update determining unit which determines whether to update the certificate revocation list, based on one of the response message and the update request message.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating the concept of a general DRM;

FIG. 2 is a block diagram illustrating the issue and update of a CRL in a DRM system according to the related art;

FIG. 3 is a diagram illustrating the management of a multi CRM according to an exemplary embodiment of the present invention;

FIG. 4 is a flowchart illustrating a CRL support method according to an exemplary embodiment of the present invention;

FIG. 5 is a flowchart illustrating a CRL support method according to another exemplary embodiment of the present invention;

FIG. 6 is a flowchart illustrating a CRL support method according to another exemplary embodiment of the present invention;

FIG. 7 is a block diagram illustrating a multi CRL support apparatus for DRM according to an exemplary embodiment of the present invention; and

FIG. 8 is a block diagram illustrating a multi CRL support apparatus for DRM according to another exemplary embodiment of the present invention.

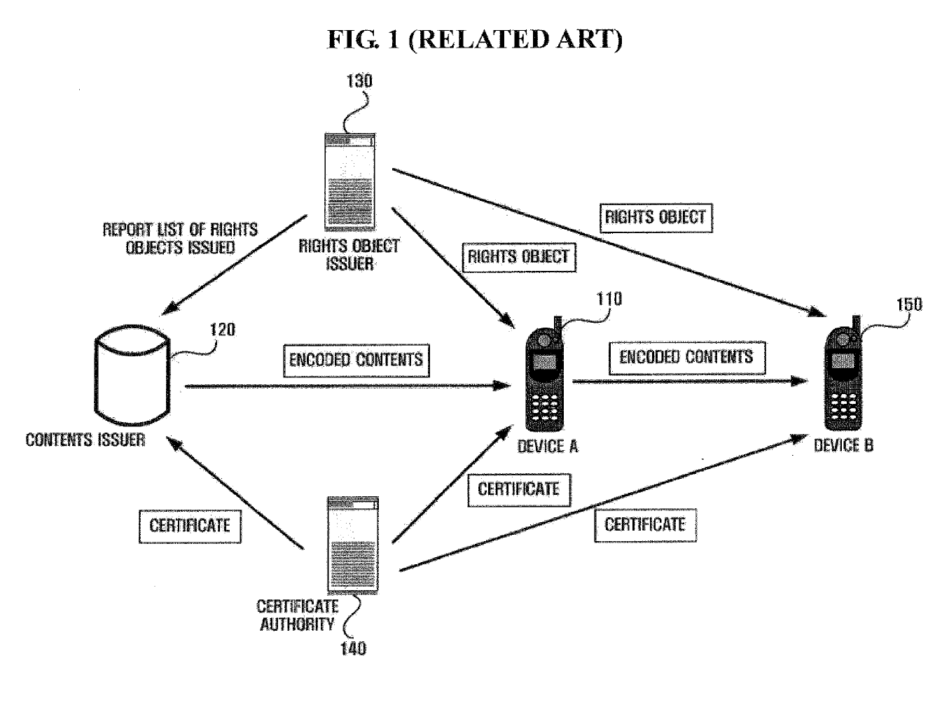

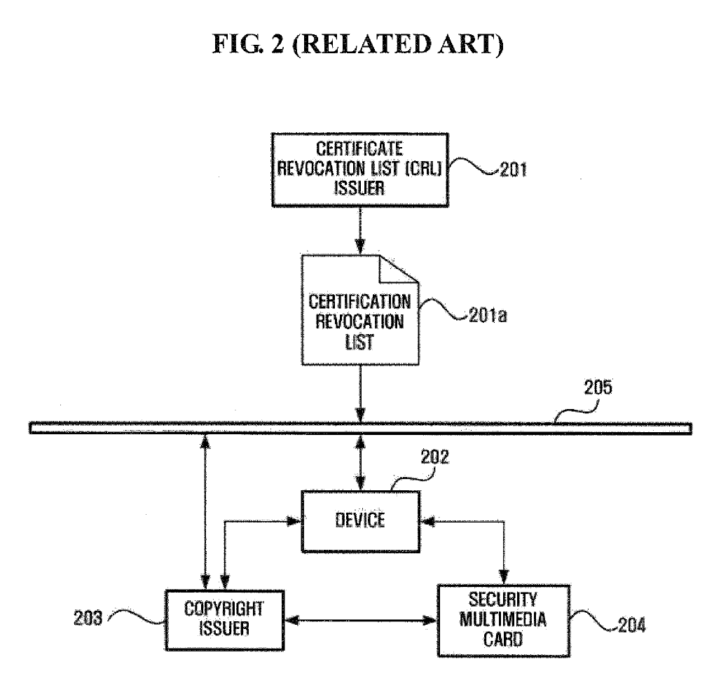

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings.

The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims.

Like reference numerals refer to like elements throughout the specification.

The present invention will be described hereinafter with reference to block diagrams or flowchart illustrations of a multi certificate revocation list support method and apparatus for digital rights management according to an exemplary embodiment thereof.

It will be understood that each block of the flowchart illustrations, and combinations of blocks in the flowchart illustrations can be implemented by computer program instructions.

These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer readable recording medium that can direct a computer or other programmable data processing apparatus to function in a particular manner, such that the instructions stored in the computer usable or computer readable recording medium produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

And each block of the block diagrams may represent a module, segment, or portion of code, which comprises one or more executable instructions for implementing the specified logical function(s).

It should also be noted that in some alternative implementations, the functions noted in the blocks may occur out of order.

For example, two blocks shown in succession may in fact be executed substantially concurrently or the blocks may sometimes be executed in reverse order depending upon the functionality involved.

The present invention will now be described more fully with reference to the accompanying drawings, in which exemplary embodiments of the invention are shown.

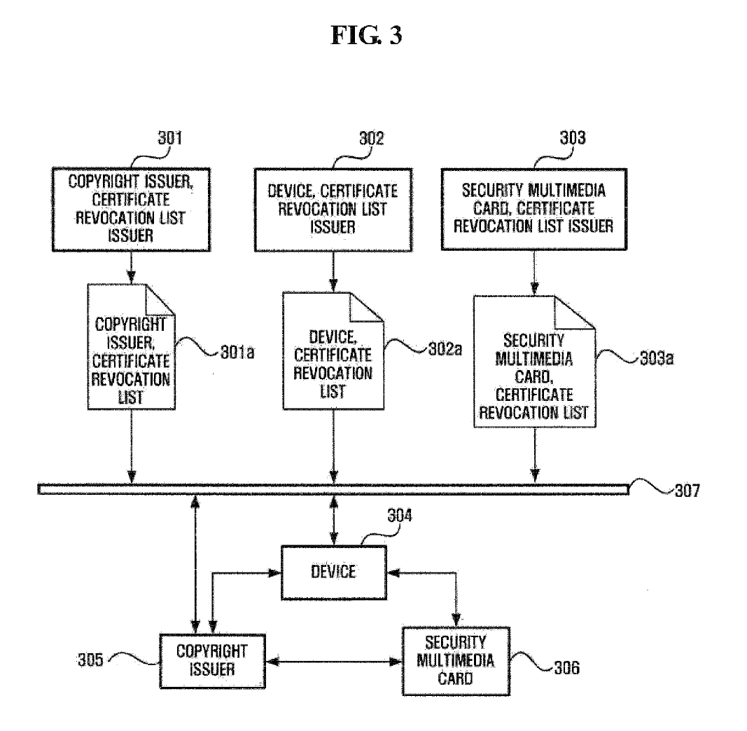

FIG. 3 is a block diagram illustrating a method of managing a CRL according to an exemplary embodiment of the present invention.

As shown in FIG. 3, a plurality of CRL issuers 301 to 303 and various devices 304 to 306 forming a DRM system are provided, and the CRL issuers 301 to 303 create CRLs 301a to 303a to effectively manage the CRLs and distribute the CRLs through a network 307.

In this case, information (for example, issuer ID) capable of identifying the CRL issuers 301 to 303 of the corresponding CRLs 301a to 303a are provided in the CRLs 301a to 303a, respectively. Therefore, the devices 304 to 306 forming the DRM system can store, exchange, and update the CRLs 301a to 303a issued by the CRL issuers 301 to 303, respectively.

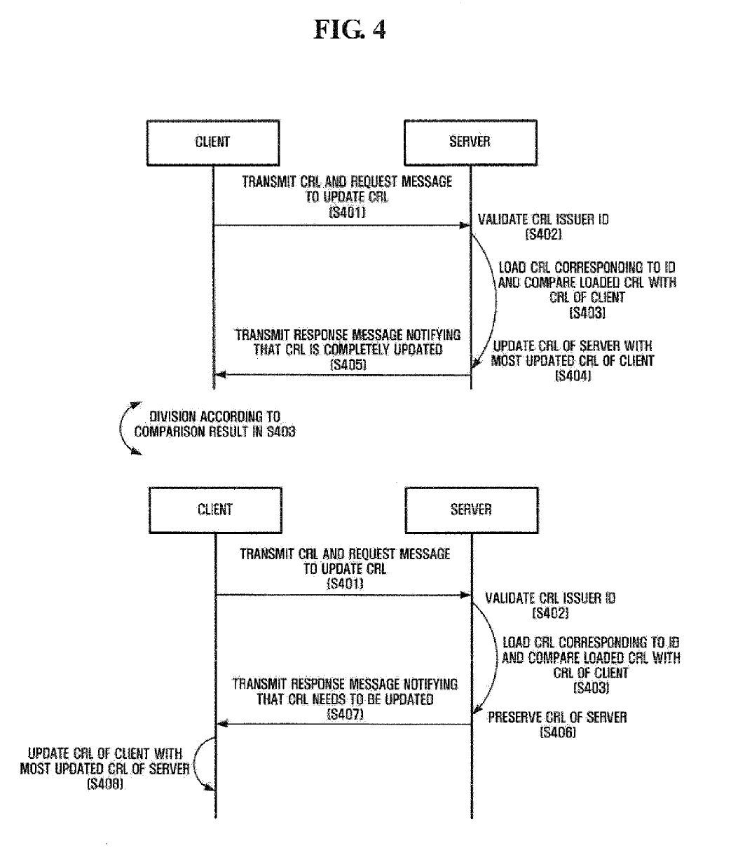

Hereinafter, a multi CRL support method and apparatus shown in FIG. 3 will be described in detail with reference to FIGS. 4 to 6.

It is assumed that a DRM system includes a client and a server, two apparatuses (the client and the server) store CRLs issued by two or more CRL issuers, and each CRL includes identification information for identifying a CRL issuer of the corresponding CRL, that is, CRL issuer ID.

In addition, it is also assumed that the two apparatuses can communicate with each other through a predetermined protocol, and one of the two apparatuses satisfies CRL test conditions and performs a CRL update.

The CRL test conditions include mutual authentication between two apparatuses and a condition that a CRL reaches a specific threshold value. One or more specific threshold values can be set for each CRL issuer ID, and when a CRL reaches a specific threshold value, some of the functions of an apparatus may be restricted.

For example, a multimedia security card CRL issuer can set a specific threshold value for indicating how many times contents stored in a corresponding security card are exchanged, and a device CRL issuer can set a specific period as a threshold value. In this case, when the number of exchanges or the corresponding period reaches a specific threshold value, access to a rights object is restricted.

Of course, after a CRL is updated, the specific threshold value is initialized, and the restrictions on the use of functions due to the previous threshold value are removed.

FIG. 4 is a flowchart illustrating a CRL support method according to an exemplary embodiment of the present invention.

First, a client transmits the CRL of its own server together with an update request message to a server (S401).

In this case, the transmission time in operation S401 corresponds to a CRL test condition.

After operation S401, the server receives the update request message and the CRL transmitted from the client, and checks a CRL issuer ID included in the received CRL (S402).

After operation S402, the server loads its own (server) CRL corresponding to the CRL issuer ID checked in operation S402, that is, its own CRL issued by the corresponding issuer, and determines whether the loaded CRL is more updated than the CRL received from the client (S403).

As the result of the determination, when the CRL received from the client is the most updated CRL, the server updates its own CRL with the CRL received from the client (S404), and transmits a response message notifying that the update has been completed to the client (S405).

For reference, in the update process of operation S404, the server may revoke its own (server) CRL and use the most updated CRL received from the client as its own (server) CRL, or the server may not revoke its own (server) CRL and may make its own (server) CRL identical with the CRL of the client with reference to the most updated CRL received from the client.

When it is determined in operation S403 that the CRL of the server is more updated than the CRL received from the client, the server preserves its own CRL (S406), and transmits a response message notifying that the CRL received from the client needs to be updated (S407).

In this case, the server may transmit its most updated CRL together with the response message.

After operation S407, the client receives the response message and the most updated CRL from the server, and updates its own CRL with the received most updated CRL (S408).

For reference, in the update process of operation S408, the client may revoke its own (client) CRL and use the most updated CRL received from the server as its own (client) CRL, or the client may not revoke its own (client) CRL and may make its own (client) CRL identical with the CRL of the server with reference to the most updated CRL received from the server.

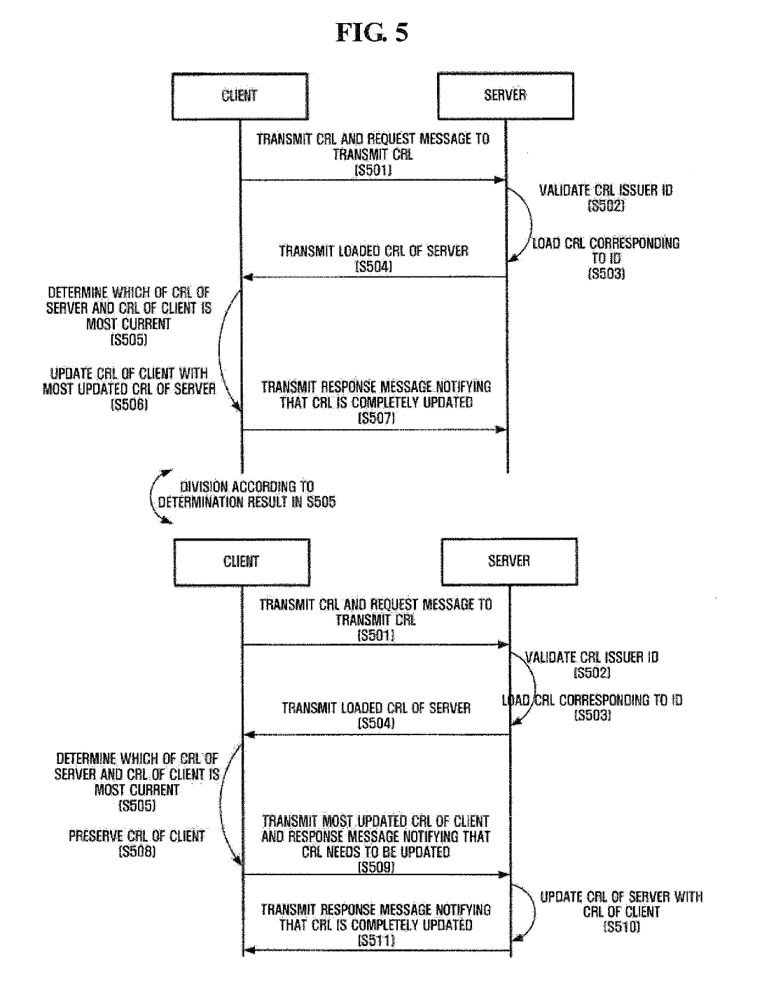

FIG. 5 is a flowchart illustrating a CRL support method according to another exemplary embodiment of the present invention.

A client transmits its own CRL including a CRL issuer ID that the client wants to check together with a transmission request message (S501).

In this case, the transmission time in operation S501 corresponds to a CRL test condition.

After operation S501, a server receives the transmission request message and the CRL from the client, and checks the CRL issuer ID included in the received CRL of the client (S502).

After operation S502, the server loads its own (server) CRL corresponding to the CRL issuer ID checked in operation S502, that is, its own CRL issued by the corresponding issuer (S503), and transmits the loaded CRL to the client (S504).

After operation S504, the client receives the CRL of the server from the server and determines whether the CRL received from the server is more updated than its own CRL (S505).

As the result of the determination, when the CRL received from the server is the most updated CRL, the client updates its own CRL with the CRL received from the server (S506), and transmits a response message notifying that the update has been completed to the server (S507).

For reference, in the update process of operation S506, the client may revoke its own (client) CRL and use the most updated CRL received from the server as its own (client) CRL, or the client may not revoke its own (client) CRL and may make its own (client) CRL identical with the CRL of the server with reference to the most updated CRL received from the server.

When it is determined in operation S506 that the CRL of the client is more updated than the CRL received from the server, the client preserves its own CRL (S508), and transmits a response message notifying that the CRL of the server needs to be updated (S509).

In this case, the client may transmit its most updated CRL together with the response message.

After operation S509, the server receives the response message and the most updated CRL from the client, and updates its own CRL with the received most updated CRL (S510), and transmits a response message notifying that the update has been completed to the client (S511).

For reference, in the update process of operation S510, the server may revoke its own (server) CRL and use the most updated CRL received from the client as its own (server) CRL, or the server may not revoke its own (server) CRL and may make its own (server) CRL identical with the CRL of the client with reference to the most updated CRL received from the client.

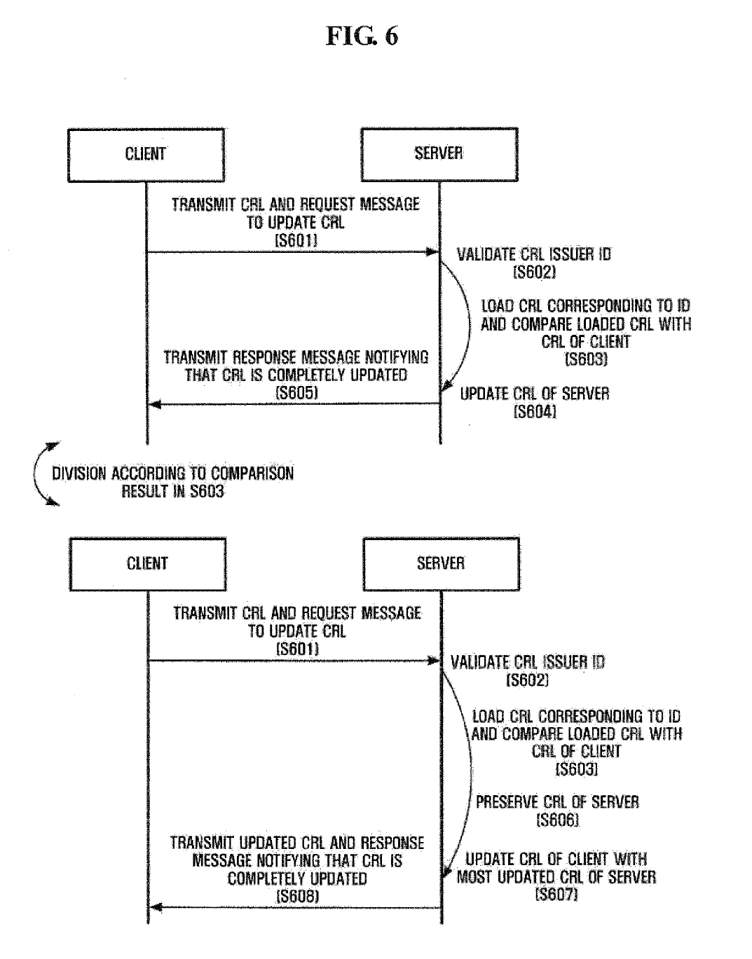

FIG. 6 is a flowchart illustrating a CRL support method according to another exemplary embodiment of the present invention.

A client transmits its own CRL including a CRL issuer ID that the client wants to check together with an update request message (S601).

In this case, the transmission time in operation S601 corresponds to a CRL test condition.

After operation S601, a server receives the update request message and the CRL from the client, and checks the CRL issuer ID included in the received CRL of the client (S602).

After operation S602, the server loads its own (server) CRL corresponding to the CRL issuer ID checked in operation S602, that is, its own CRL issued by the corresponding issuer, and determines whether the loaded CRL is more updated than the CRL received from the client (S603).

As the result of the determination, when the CRL received from the client is the most updated CRL, the server updates its own CRL with the CRL received from the client (S604), and transmits a response message notifying that the update has been completed to the client (S605).

For reference, in the update process of operation S604, the server may revoke its own (server) CRL and use the most updated CRL received from the client as its own (client) CRL, or the server may not revoke its own (server) CRL and may make its own (server) CRL identical with the CRL of the client with reference to the most updated CRL received from the client.

When it is determined in operation S603 that the CRL of the server is more updated than the CRL received from the client, the server preserves its own CRL (S606), updates the CRL received from the client (S607), and transmits to the client a response message notifying that the CRL of the client has been updated and the updated CRL of the client (S608).

For reference, after operation S606, the server may revoke the CRL of the client and transmit its (server) most updated CRL together with a response message to the client, and the client may use the most updated CRL received from the server. Alternatively, the server may update the CRL received from the client to be identical with its (server) most updated CRL and transmit to the client a response message notifying that the CRL of the client has been updated together with the updated CRL of the client. For convenience of explanation, FIG. 6 shows the latter case as an example.

FIG. 7 is a block diagram illustrating the structure of a multi CRL support apparatus for DRM according to an exemplary embodiment of the present invention.

In this embodiment, a multi CRL support apparatus 700 for DRM includes an ID validation unit 701 that receives a first CRL and validates an issuer ID of the first CRL, an update determining unit 702 that loads a second CRL corresponding to the issuer ID validated in the ID validation unit 701 and determines whether the first CRL is the most updated, and an update unit 703 that updates one of the first and second CRLs with the most updated CRL according to the result determined by the update determining unit 702.

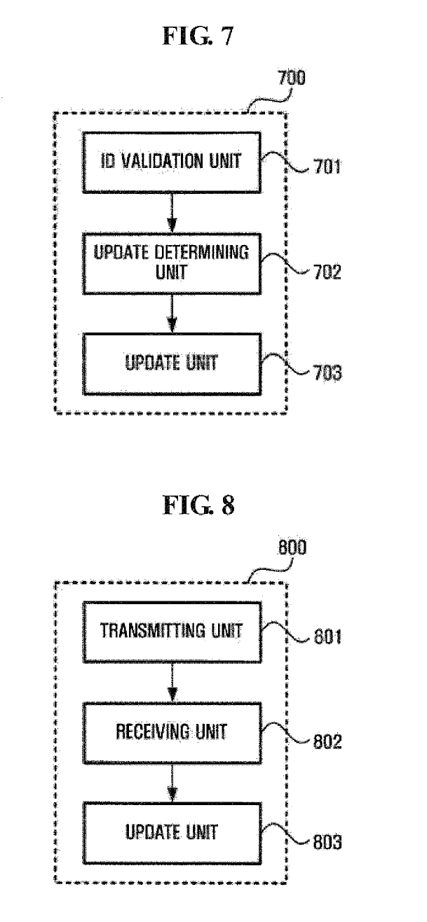

FIG. 8 is a block diagram illustrating the structure of a multi CRL support apparatus for DRM according to another exemplary embodiment of the present invention.

In this embodiment, a multi CRL support apparatus 800 for DRM includes a transmitting unit 801 that transmits a first CRL including an issuer ID of a CRL, a receiving unit 802 that receives a response to the completion of the update of the first CRL or a response to a request to update the first CRL according to whether the first CRL transmitted from the transmitting unit 801 is the most updated, and an update unit 803 that determines whether to update the first CRL according to the response received by the receiving unit 802.

In this embodiment, each of the components shown in FIGS. 7 and 8 according to the exemplary embodiments of the present invention means, but is not limited to, a software or hardware component, such as a field programmable gate array (FPGA) or an application specific integrated circuit (ASIC), which performs certain tasks. Each component may advantageously be configured to reside on an addressable storage medium and configured to execute on one or more processors. Thus, a component may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables, noting that alternative embodiments are equally available. In addition, the functionality provided for by the components and modules may be combined into fewer components and modules or further separated into additional components and modules.

For reference, it is assumed that a DRM system includes a client and a server, two apparatuses (the client and the server) store CRLs issued by two or more CRL issuers, and each CRL includes ID for identifying a CRL issuer of the corresponding CRL, that is, CRL issuer ID.

In this case, the apparatus 700 shown in FIG. 7 may include a server, and the apparatus 800 shown in FIG. 8 may include a client. Contrarily, the apparatus 800 shown in FIG. 8 may include a server, and the apparatus 700 shown in FIG. 7 may include a client. In addition, both the server and the client may include the update determining units 702 in order to reliably determine whether to update a CRL or not.

For convenience of explanation, in this embodiment, it is assumed that the apparatus 700 shown in FIG. 7 includes a server and the apparatus 800 shown in FIG. 8 includes a client.

First, the apparatus 800 shown in FIG. 8, that is, the transmitting unit 801 of the client, transmits a CRL including a CRL issuer ID to the apparatus 700 shown in FIG. 7, that is, the server.

For reference, in this embodiment, the DRM system transmits a CRL including a CRL issuer ID to test the CRL, when mutual authentication between apparatuses is needed, and when CRL reaches a specific threshold value.

In this case, one or more specific threshold values can be set for each CRL issuer ID, and when a CRL reaches a specific threshold value, some of the functions of an apparatus may be restricted.

For example, a multimedia security card CRL issuer can set a specific threshold value for indicating how many times contents stored in a corresponding security card are exchanged, and a device CRL issuer can set a specific period as a threshold value. In this case, when the number of exchanges or the corresponding period reaches a specific threshold value, access to a rights object is restricted.

Of course, after a CRL is updated, the specific threshold value is initialized, and the restrictions on the use of functions due to the previous threshold value are removed.

The ID validation unit 701 of the server receives the CRL (hereinafter, referred to as a first CRL) transmitted from the transmitting unit 801 of the client, and validates a CRL issuer ID, which is an issuer ID of the received first CRL.

The CRL issuer ID is identity for identifying a CRL issuer in the CRL. In this embodiment, the structure of the CRL issuer may be classified into a host, which is an apparatus for supporting the reproduction of copyrighted contents, a CRL issuer that varies according to the type of device and includes secure removable media that safely store and manage related information so as to reproduce the copyrighted contents, a CRL issuer according to the structure of a DRM system, such as a rights issuer or a certificate authority, a CRL issuer according to a DRM system operator, such as a contents service provider and a DRM apparatus manufacturer, and a CRL issuer according to the type of DRM, such as Open Mobile Alliance (OMA), DRM, or Microsoft Window Media (MSW).

For reference, the structure of the CRL issuer may be classified into various types in addition to the above, if necessary, but the present invention is not limited thereto.

Therefore, the ID validation unit 701 of the server validates the CRL issuer ID of the received first CRL on the basis of the CRL issuer ID and determines which CRL the client wants to verify.

The update determining unit 702 of the server loads a CRL (hereinafter, referred to as a second CRL) corresponding to the first CRL issuer ID, that is, a CRL having the same CRL issuer ID from a storage of the server, on the basis of the first CRL issuer ID validated by the ID validation unit 701.

For reference, the storage of the server may store encoded contents, rights objects, a server certificate, and a CRL.

The update determining unit 702 of the server loads the second CRL, determines which of the first and second CRLs is the most updated, and transmits the result of the determination to the update unit 703.

In this case, the determination of the most updated CRL is based on a CRL issue date, and the update determining unit 702 determines that the earlier the CRL issue date is, the most updated the CRL is issued.

The update unit 703 of the server determines whether to update the first CRL or the second CRL on the basis of the result of the comparison between the first and second CRLs transmitted from the update determining unit 702 and updates one of the first and second CRLs with the most updated CRL.

For example, when the first CRL of the client is more updated than the second CRL of the server, the update unit 703 of the server updates the second CRL with the first CRL. In this update process, the update unit 703 of the server may revoke the second CRL stored in a storage, store the first CRL of the client as a new CRL in the storage, and transmit to the client a response message notifying that the second CRL has been updated with the first CRL of the client.

On the other hand, when the second CRL of the server is more updated than the first CRL of the client, the update unit 703 of the server updates the first CRL with the second CRL. In this update process, the update unit 703 of the server may revoke the first CRL of the client, and transmit to the client a response message notifying that the first CRL has been revoked together with the CRL of the server, thereby updating the CRL of the client with the most updated CRL of the server, or the update unit 703 of the server may not revoke the first CRL of the client, update the first CRL of the client with the second CRL of the server, and transmit to the client a response message notifying that the first CRL has been updated with the second CRL together with the updated CRL of the client. Alternatively, the update unit 703 of the server may not revoke the first CRL of the client, transmit a response message notifying that CRL needs to be updated together with the second CRL of the server to the client. Then, the client may receive the most updated CRL of the server and update its own CRL with the received most updated CRL of the server.

If the issue date of the first CRL of the client is identical with that of the second CRL of the server, communication between the server and the client is maintained without updating a CRL.

Meanwhile, the receiving unit 802 of the client receives a response message notifying that the first CRL has been completed or an update request message from the update unit 703 of the server according to whether the first CRL transmitted from the transmitting unit 801 of the client is the most updated CRL.

For example, when the first CRL transmitted from the client is more updated than the second CRL of the server, the update unit 703 of the server updates the second CRL with the first CRL, and transmits to the client a response message notifying that the second CRL has been updated with the first CRL of the client. Then, the receiving unit 802 of the client receives the response message.

Subsequently, the update unit 803 of the client stops the updates of the CRLs with reference to the response message received from the receiving unit 802 and maintains communication with the server.

When the second CRL of the server is more updated than the first CRL of the client, the update unit 703 of the server transmits to the client a response message notifying that the first CRL needs to be updated together with the second CRL of the server. Then, the receiving unit 802 of the client receives the response message and the second CRL of the server.

Subsequently, the update unit 803 of the client revokes the first CRL stored in a storage with reference to the response message received from the receiving unit 802, stores the second CRL of the server received from the receiving unit 802 as a new CRL in the storage, and maintains communication with the server.

Alternatively, when the second CRL of the server is more updated than the first CRL transmitted from the client, the update unit 703 of the server may update the first CRL of the client with the second CRL of the server, and transmit to the client a response message notifying that the first CRL has been updated with the second CRL together with the updated CRL of the client. Then, the receiving unit 802 of the client may receive the response message and the updated CRL, stop the updates of the CRLs, and maintain communication with the server.

Although the present invention has been described in connection with the exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

As described above, the multi certificate revocation list support method and apparatus for digital rights management according to the above-described exemplary embodiments of the present invention has the following effects.

It is possible to administer CRLs for the kind of certificate authorities, the type of apparatus, and the type of CRL issuers, and thus there is no necessity for administering unassigned CRLs, which makes it possible to reduce the amount of CRLs administered by one apparatus and improve the efficiency of management.

In addition, it is possible to directly administer a CRL required for a CRL issuer. Therefore, when CRLs issued by several certificate authorities are stored in one apparatus, it is possible to prevent conflict among different CRL issuers.

Further, in an apparatus capable of supporting multi-DRM, when a specific DRM is operated, it is possible to administer CRLs required for each DRM and each CRL issuer, and thus to individually manage a CRL related to each type of DRM.

What is claimed is:

1. A multi certificate revocation list support method for digital rights management, the method comprising:
receiving a first certificate revocation list and validating an issuer identification (ID) of the first certificate revocation list;
loading a second certificate revocation list corresponding to the issuer ID and determining which of the first and second certificate revocation lists is the most updated certificate revocation list; and
updating one of the first and second certificate revocation lists with the most updated certificate revocation list, based on a result of the determining.

2. The method of claim 1, wherein the validating the issuer ID is performed during mutual authentication between apparatuses.

3. The method of claim 1, wherein the validating the issuer ID is performed when one of a value set in the first certificate revocation list and a value set in the second certificate revocation list reaches a threshold value.

4. The method of claim 3, wherein the value set in the first and second certificate revocation lists is set for each issuer having an ID.

5. The method of claim 1, wherein, in the updating one of the first and second certificate revocation lists, the second certificate revocation list is updated with the first certificate revocation list, based on the result of the determining.

6. The method of claim 1, wherein, in the updating one of the first and second certificate revocation lists, the first certificate revocation list is updated with the second certificate revocation list, based on the result of the determining.

7. The method of claim 1, wherein the updating one of the first and second certificate revocation lists comprises requesting to update the first certificate revocation list with the second certificate revocation list, based on the result of the determining.

8. A multi certificate revocation list support method for digital rights management, the method comprising:
transmitting a certificate revocation list including an issuer identification (ID) of the certificate revocation list;
receiving one of a response message notifying that the certificate revocation list has been updated and an update request message according to whether the certificate revocation list is a most updated certificate revocation list; and
determining whether to update the certificate revocation list, based on one of the response message and the update request message.

9. The method of claim 8, wherein the transmitting the certificate revocation list is performed during mutual authentication between apparatuses.

10. The method of claim 8, wherein the transmitting the certificate revocation list is performed when a value set in the certificate revocation list reaches a threshold value.

11. The method of claim 10, wherein the value set in the certificate revocation list is set for each issuer having an ID.

12. The method of claim 8, wherein, when a response to the update request message is received, the most updated certificate revocation list is received.

13. A multi certificate revocation list support apparatus for digital rights management, the apparatus comprising:
an identification (ID) validation unit which receives a first certificate revocation list and validates an issuer ID of the first certificate revocation list;
an update determining unit which loads a second certificate revocation list corresponding to the issuer ID and determines which of the first and second certificate revocation lists is the most updated certificate revocation list; and
an update unit which updates one of the first and second certificate revocation lists with the most updated certificate revocation list, based on a result of the determination by the update determining unit.

14. The apparatus of claim 13, wherein the ID validation unit validates the issuer ID during mutual authentication between apparatuses.

15. The apparatus of claim 13, wherein the ID validation unit validates the issuer ID when one of a value set in the first certificate revocation list and a value set in the second certificate revocation list reaches a threshold value.

16. The apparatus of claim 15, wherein the value set in the first and second certificate revocation lists is set for each issuer having an ID.

17. The apparatus of claim 13, wherein the update unit updates the second certificate revocation list with the first certificate revocation list, based on the result of the determination.

18. The apparatus of claim 13, wherein the update unit updates the first certificate revocation list with the second certificate revocation list, based on the result of the determination.

19. The apparatus of claim 13, wherein the update unit requests to update the first certificate revocation list with the second certificate revocation list, based on the result of the determination.

20. A multi certificate revocation list support apparatus for digital rights management, the apparatus comprising:
a transmitting unit which transmits a certificate revocation list including an issuer identification (ID) of the certificate revocation list;
a receiving unit which receives one of a response message notifying that the certificate revocation list has been updated and an update request message according to whether the certificate revocation list is a most updated certificate revocation list; and
an update determining unit which determines whether to update the certificate revocation list, based on one of the response message and the update request message.

21. The apparatus of claim 20, wherein the transmitting unit transmits the certificate revocation list during mutual authentication between apparatuses.

22. The apparatus of claim 20, wherein the transmitting unit transmits the certificate revocation list when a value set in the certificate revocation list reaches a threshold value.

23. The apparatus of claim 22, wherein the value set in the certificate revocation list is set for each issuer having an ID.

24. The apparatus of claim 20, wherein, when receiving a response to the update request message, the receiving unit receives the most updated certificate revocation list.

25. A computer readable recording medium storing a computer program for performing a multi certificate revocation list support method for digital rights management, the method comprising:
receiving a first certificate revocation list and validating an issuer identification (ID) of the first certificate revocation list;
loading a second certificate revocation list corresponding to the issuer ID and determining which of the first and second certificate revocation lists is the most updated certificate revocation list; and
updating one of the first and second certificate revocation lists with the most updated certificate revocation list, based on a result of the determining.

26. A computer readable recording medium storing a computer program for performing a multi certificate revocation list support method for digital rights management, the method comprising:
transmitting a certificate revocation list including an issuer identification of the certificate revocation list;
receiving one of a response message notifying that the certificate revocation list has been updated and an update request message according to whether the certificate revocation list is a most updated certificate revocation list; and
determining whether to update the certificate revocation list, based on one of the response message and the update request message.
